(19) United States
(12) Patent Application Publication
(10) Pub. No.: US 2013/0145898 A1
(43) Pub. Date: Jun. 13, 2013

(54) POWER DELIVERY DEVICE FOR VEHICLE

(71) Applicants: Kyungha Kim, Yongin (KR); Tal Chol Kim, Incheon (KR); Ki Nam Kim, Seongnam (KR); Hee Ra Lee, Anyang (KR); Yeonho Kim, Suwon (KR)

(72) Inventors: Kyungha Kim, Yongin (KR); Tal Chol Kim, Incheon (KR); Ki Nam Kim, Seongnam (KR); Hee Ra Lee, Anyang (KR); Yeonho Kim, Suwon (KR)

(73) Assignee: HYUNDAI MOTOR COMPANY, Seoul (KR)

(21) Appl. No.: 13/558,909

(22) Filed: Jul. 26, 2012

(30) Foreign Application Priority Data
Dec. 9, 2011 (KR) 10-2011-0132231

(51) Int. Cl. F16H 37/06

(52) U.S. Cl. 74/665 D

(57) ABSTRACT

Disclosed is a power delivery device for a vehicle that improves power delivery efficiency. More specifically, the power delivery device includes a first motor having a first drive shaft directly connected to an output shaft of an engine, a second motor having a second drive shaft directly connected to an input shaft of a gearbox, and a clutch selectively connecting the output shaft of the engine with the input shaft of the gearbox.

### CROSS-REFERENCE TO RELATED APPLICATION

This application claims priority to and the benefit of Korean Patent Application No. 10-2011-0132231 filed in the Korean Intellectual Property Office on Dec. 9, 2011, the entire contents of which are incorporated herein by reference.

### BACKGROUND OF THE INVENTION

(a) Field of the Invention

The present invention relates to a power delivery device for a vehicle. More particularly, the present invention relates to a power delivery device for a vehicle that improves power delivery efficiency.

(b) Description of the Related Art

Electric vehicles are defined as any vehicle that is driven by at least one electric motor as a power source. One type of electric vehicle is a hybrid vehicle. Some hybrid vehicles are powered by both a gas combustion engine and an electric motor to provide a more fuel efficient alternative to a purely internal combustion and a purely electric powered vehicle.

As described above, the hybrid vehicle includes a motor and an engine. Hybrid vehicles which have a starting motor include a power train in which a starting motor, a drive motor, and an engine are connected to at least one planetary gear set and a plurality of friction members. Also, a plurality of shifting modes are realized depending on the structural connections of the planetary gear set and the friction members. More specifically, the starting motor is configured to rotate a crankshaft and start the engine, and the drive motor is configured to generate a torque and rotate a drive wheel of a vehicle. The starting motor and the drive motor receive electrical power from a battery to be operated and a drive shaft is rotated by the operation of the drive motor and the engine.

However, in the typical configuration, a starting motor is connected to an engine through a belt in a power delivery device which often leads to deteriorated power delivery efficiency. Also, the capacity of the starting motor is increased thus increasing the fuel consumption efficiency. Finally, the speed of the hybrid vehicle is often limited to a low speed when a hybrid vehicle is in the electric motor driving mode.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a power delivery device for a vehicle having advantages of being able to improve power delivery efficiency. More specifically, a power delivery device of a vehicle that includes an engine, a motor, and a gearbox shifting gears according to an exemplary embodiment of the present invention may include a first motor having a first drive shaft connected to an output shaft of the engine, a second motor having a second drive shaft connected to an input shaft of the gearbox, and a clutch configured to selectively connect the output shaft of the engine with the input shaft of the gearbox. In particular, the clutch may be disposed within a drive-train between the first motor and the second motor.

The power delivery device of a vehicle may further include a damping device that is configured to absorb rotational impact that is formed when torque is transferred from the engine to the gearbox. The damping device may be disposed in an output shaft direction of the first motor, and the clutch may be disposed within the drive train between the damping device and the second motor. The drive shaft of the first motor may cover an external circumference of the damping device to be engaged thereto. Furthermore, the damping device may be disposed in an interior area of a space forming the first motor.

As described above, a starting motor in the illustrative embodiment of the present invention is directly connected to an output shaft of an engine to improve the startability of the engine and the charging characteristics of the battery in an exemplary embodiment of the present invention. Further, the first motor that is connected to the output shaft of an engine and the second motor that is connected to the input shaft of a gearbox are simultaneously operated in an electric motor drive mode to improve power delivery efficiency thereof.

### BRIEF DESCRIPTION OF THE DRAWINGS

FIG. 1 is a schematic diagram of a power delivery device of an eco-friendly vehicle according to an exemplary embodiment of the present invention.

FIG. 2 is a schematic diagram of a power delivery device of an eco-friendly vehicle according to an exemplary embodiment of the present invention.

FIG. 3 shows that a power delivery device of an eco-friendly vehicle is mounted on a rear drive vehicle according to an exemplary embodiment of the present invention.

### <Description of Symbols>

10: engine
20: first motor
30: second motor
40: gearbox
50: clutch
60: damping device
70: differential apparatus

### DETAILED DESCRIPTION OF THE EMBODIMENTS

An exemplary embodiment of the present invention will hereinafter be described in detail with reference to the accompanying drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

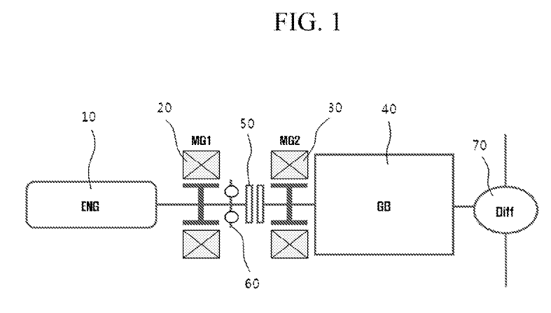

FIG. 1 is a schematic diagram of a power delivery device of an eco-friendly vehicle according to an exemplary embodiment of the present invention. As shown in FIG. 1, an environmentally-friendly power delivery device of a vehicle according to an exemplary embodiment of the present invention includes an engine 10, a first motor 20, a second motor 30, a gearbox 40, a clutch 50, a damping device 60, and a differential apparatus 70.

FIG. 1 shows that the engine 10, the first motor 20, the second motor 30, gearbox 40, the clutch 50, and the damping device 60 are disposed on a power delivery line or a drive train. Particularly, the arrangement and the connectional relationship of the engine 10, the first motor 20, the second motor 30, the clutch 50, and the damping device 60 are described in an exemplary embodiment of the present invention.

The first motor 20 and the engine 10 in the illustrative embodiment of the present invention may be coaxially disposed with each other. Also, a rotor of the first motor 20 may be fixedly or directly connected to the output shaft of the engine 10.

Here, the rotor is a part that is connected to the drive shaft of the motors 20 and 30 and is rotated by the motors 20 and 30 accordingly. Further, the rotor can be widely varied into various shapes so that the power delivery is effectively executed. Meanwhile, the rotor of the first motor 20 is directly connected to the output shaft of the engine 10 to improve the starting and operating efficiency of the engine 10. Also, when the first motor 20 operates as a generator by the engine 10, the generating efficiency is improved. The second motor 30 and the gearbox 40 may also be coaxially disposed with each other. Also, the rotor of the second motor 30 may be fixedly connected to the input shaft of the gearbox 40.

The clutch 50 is preferably disposed on the power delivery line between the first motor 20 and the second motor 30. The clutch 50 may include an inner ring and an outer ring. Further, the inner ring and the outer ring may be selectively engaged so that a constituent element that is connected to the inner ring and a constituent element that is connected to the outer ring executed effectively the power delivery.

Either the inner ring or the outer ring of the clutch may be directly connected to the rotor of the first motor 20. Also, the other one of the inner ring or the outer ring of the clutch 50 may be directly connected to the rotor of the second motor 30. That is, the clutch 50 selectively connects the first motor 20 with the second motor 30. In detail, the first motor 20 and the second motor 30 can be independently or simultaneously operated. Here, the first motor 20 can be operated to start the engine or can be operated as a drive motor to move the vehicle.

The damping device 60 is preferably disposed on a power delivery line between the first motor 20 and the clutch 50. Also, the damping device 60 may be connected to the rotor of the first motor 20. The differential apparatus 70 may be connected to the output shaft of the gearbox 40. Also, at least one planetary gear set (not shown) and a plurality of friction element (not shown) may be disposed in the gearbox 40.

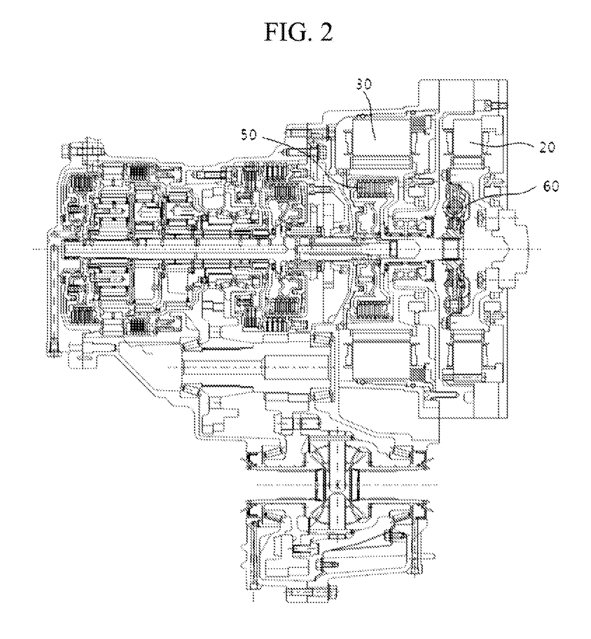

FIG. 2 is a schematic diagram of a power delivery device of an eco-friendly vehicle according to an exemplary embodiment of the present invention. FIG. 2 shows that the rotor of the first motor 20 covers an external circumference of the damping device 60. Also, the damping device 60 can be disposed in the first motor 20 that is directly connected to the engine 10. Accordingly, the space is effectively used and the device is easily mounted as a result.

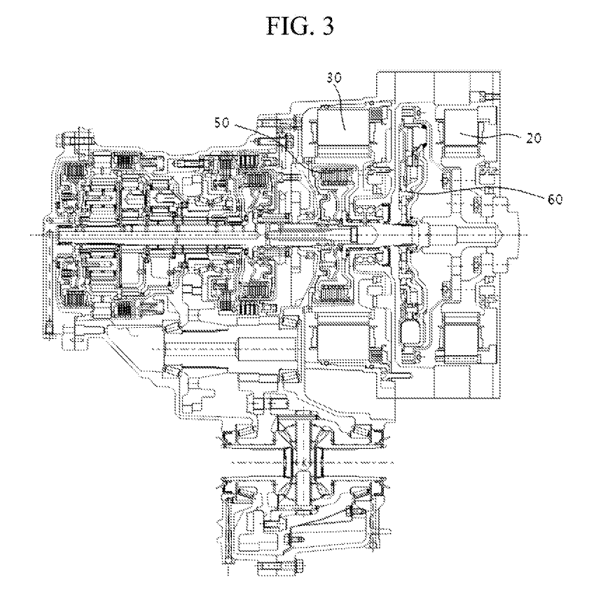

FIG. 3 shows that a power delivery device of an eco-friendly vehicle is mounted on a rear drive vehicle according to an exemplary embodiment of the present invention. However, the illustrative embodiment of the present invention is not limited to such. Furthermore, as shown in the drawings, the clutch 50 can be disposed on an output shaft direction of the second motor 30 and the clutch 50 can be disposed in an interior area of the space forming the second motor 30.

As described above, the first motor 20 is directly connected to the engine 10 and the two motors 20 and 30 are simultaneously operated in the electric motor operation mode, and therefore the operating efficiency and the fuel efficiency can be improved according to an exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A power delivery device of a vehicle that includes an engine, a motor, and a gearbox, comprising;
a first motor having a first drive shaft directly connected to an output shaft of the engine;
a second motor having a second drive shaft connected to an input shaft of the gearbox; and
a clutch configured to selectively connect the output shaft of the engine with the input shaft of the gearbox.

2. The power delivery device of a vehicle of claim 1, wherein the clutch is disposed within a drive-train between the first motor and the second motor.

3. The power delivery device of a vehicle of claim 2, further comprising a damping device configured to absorb rotational impact that is formed when torque is transferred from the engine to the gearbox.

4. The power delivery device of a vehicle of claim 3, wherein the damping device is disposed in an output shaft direction of the first motor.

5. The power delivery device of a vehicle of claim 4, wherein the clutch is disposed within the drive train between the damping device and the second motor.

6. The power delivery device of a vehicle of claim 4, wherein the drive shaft of the first motor covers an external circumference of the damping device to be engaged thereto.

7. The power delivery device of a vehicle of claim 4, wherein the damping device is disposed in an interior area of a space forming the first motor.
